(19) United States
(12) Patent Application Publication
(10) Pub. No.: US 2019/0122516 A1
(43) Pub. Date: Apr. 25, 2019

(54) THREAT DETECTION AND WARNING SYSTEM

(71) Applicant: L3 TECHNOLOGIES, INC., New York, NY (US)

(72) Inventors: Leo LORENZETTI, Hamburg, NJ (US); Amar PARMAR, Richmond, CA (US); Hubert BELSER, Boulder, CO (US); Jim DOUGLAS, Los Gatos, CA (US)

(73) Assignee: L3 TECHNOLOGIES, INC., New York, NY (US)

(21) Appl. No.: 15/788,318

(22) Filed: Oct. 19, 2017

(51) Int. Cl. G08B 21/02; G06Q 50/26

(52) U.S. Cl. CPC G08B 21/02; G06F 3/16; G06Q 50/26

(57) ABSTRACT

A threat detection and warning system for a law enforcement officer includes a recording/sensing device, computing device, and device for providing feedback to the officer. The recording device is controlled manually by the user or can be automatically triggered by either an external or internally derived signal. An external signal can be from another similar device already recording, a signal from a vehicle-based device that has been triggered or any other device within range. An internal trigger can be derived by analyzing locally collected data by the computing device. The computing device can analyze data from the recording device looking for threats or situations of interest or persons of interest to the officer. These threats can include weapons or simply an individual acting in a threatening manner. Fast feedback to the officer can be provided by an augmented reality user interface, which can include a display visor, glasses, contact lenses, wrist-worn devices, cell phones, etc.

### TECHNICAL FIELD

The present invention relates to first-responder assistance devices and methods, and in particular relates to a threat detection and warning system for law enforcement officers.

### BACKGROUND

Law enforcement officers increasingly are exposed to dangerous situations, oftentimes needing to make life and death decisions in a matter of seconds to secure his and/or a citizen's safety. In some cases, the officer is in contact with a group of individuals or is patrolling a highly populated area. In these conditions, it can be increasingly difficult for a law enforcement officer to quickly identify and assess existing or growing threats using his senses alone. Body-worn video recording devices are used to record interactions between law enforcement officers and the public. Such recordings provide a secure recording of the events that can be used to review and assess past events. However, these devices do not provide contemporaneous feedback to the law enforcement officer to assist him/her in patrolling or evaluating a situation. Therefore, a need exist for a threat detection and warning system that can analyze data and can provide feedback to a law enforcement officer in a timely manner.

### SUMMARY OF THE INVENTION

Generally described, the present invention relates to a threat detection and warning system for law enforcement officers. The device generally includes a body-worn recording or sensing device, a computing device, and a user interface device. The recording/sensing device collects data from one or more sensors and the data is sent to the computing device. The computing device analyzes the data using algorithms to identify important information or threats. The threats then are identified/communicated to the law enforcement officer using the user interface device.

In example embodiments, the recording device can record video data. Analysis can include facial recognition to match an individual to a known wanted list or missing persons. Analysis can also include identifying weapons that may be otherwise obscured or not readily noticed by the officer. In some situations, the invention can more easily determine the difference between a cell phone and a weapon in someone's hand and therefore can reduce mistakes made by officers in the field.

In one example embodiment, the system can include a body-worn computing device to perform the analysis. In another example embodiment, the system is operable to transmit video data or other key data to a processor not located on the officer's person, such as at the vehicle or in the cloud via a Wi-Fi hotspot or cellular connection.

Upon identifying a threat, the system can automatically begin recording the incident for archival and investigative purposes. The video captures the incident from the officer's perspective and include metadata, at minimum, to document the time, date, location, officer, and threat detected. Upon identifying a threat, the device notifies the user through audible, visual or vibratory feedback as appropriate for the situation. In some cases, it may not be desirable to have an audible feedback so as to conceal from the person(s) representing such a threat that he or she has been found out. Feedback can also be communicated to the officer to reflect the confidence level of the threat detection.

An example method according to the present invention comprises the steps of: (a) capturing data from a body-worn sensor (such as audio or video); (b) analyzing the captured data to assess possible threats; and (c) communicating the assessed threat to the law enforcement officer wearing the sensor. Optionally, the method also includes recording the captured data or otherwise preserving the data.

### BRIEF DESCRIPTION OF THE DRAWINGS

FIG. 1 is a schematic, high-level view of a threat detection and warning system for a law enforcement officer according to a first example embodiment of the present invention, showing a body-worn recording device, a computing device, and a user interface device all worn on the law enforcement officer.

FIG. 2 is a schematic, high-level view of a threat detection and warning system for a law enforcement officer according to a second example embodiment of the present invention, showing a body-worn recording device and a user interface device worn on the law enforcement officer and a computing device external to the law enforcement officer.

FIG. 3 is a schematic, high-level view of a threat detection and warning system for a law enforcement officer according to a third example embodiment of the present invention, showing a body-worn recording device, a computing device, and a user interface device all worn on the law enforcement officer wherein the computing device receives data from sensors and other threat detections systems external to the law enforcement officer.

FIG. 4 is a schematic illustration of an example Augmented Reality User Interface device for use as the user interface device in the example embodiments of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

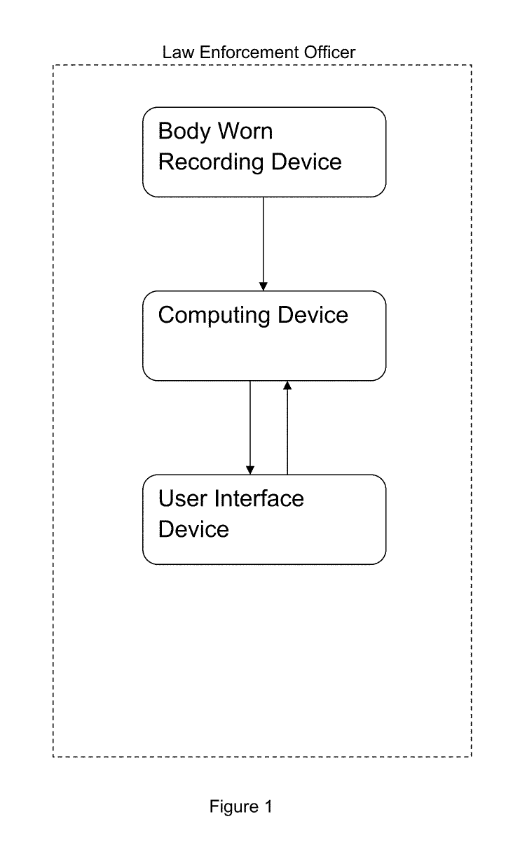

With reference now to the drawing figures, FIGS. 1-3 show various aspects, components, and modes of use of a threat detection and warning system for law enforcement officers according to example embodiments of the invention. The threat detection and warning system generally includes a body-worn recording or sensing device, a computing device, and a user interface device. The recording device collects data from one or more sensors and the data is sent to the computing device. The computing device analyzes the data using algorithms to identify important information or threats. The threats are communicated to the law enforcement officer through the user interface device.

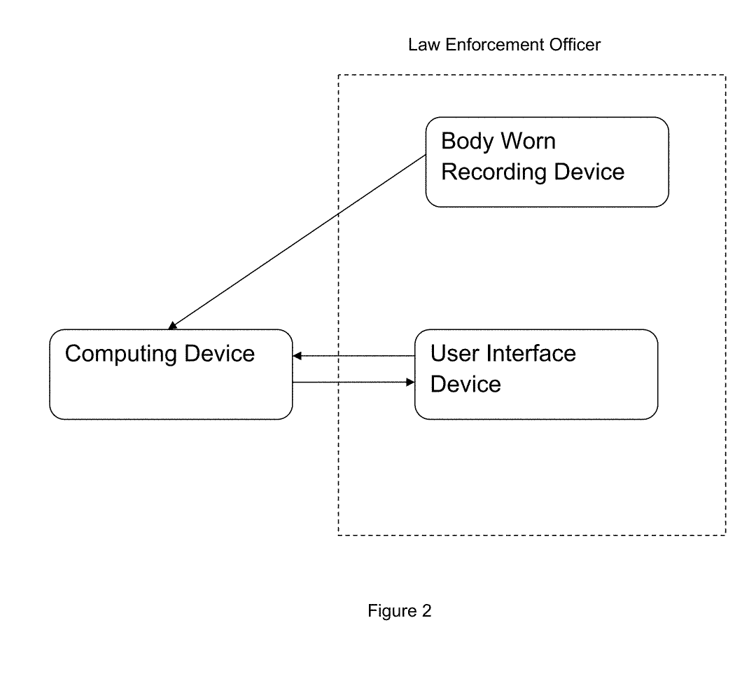

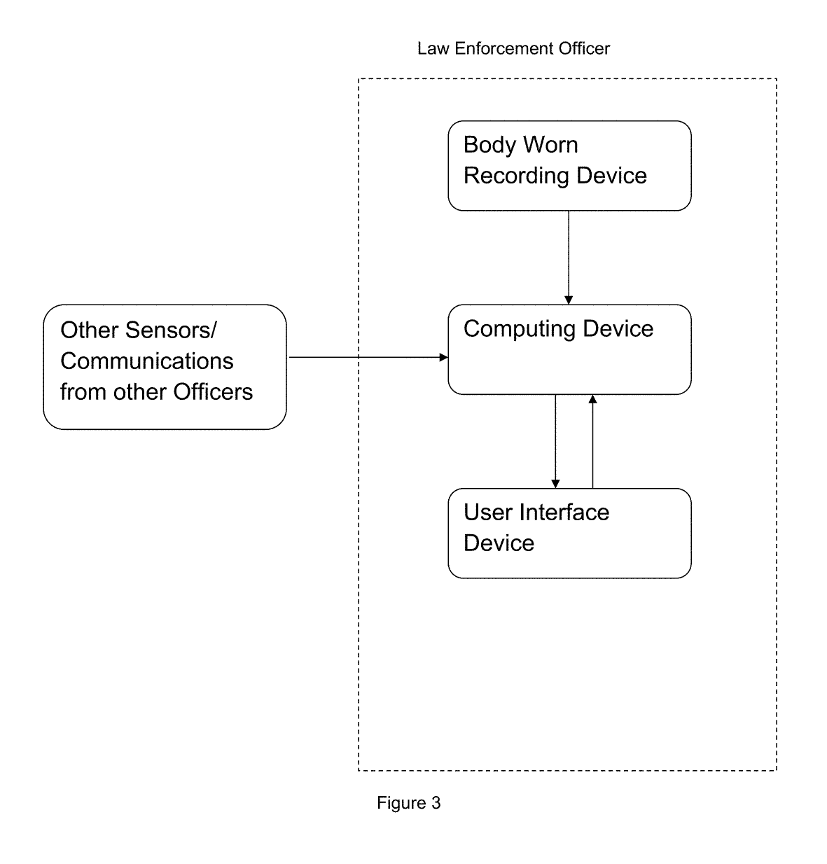

In the example embodiment of FIG. 1, the body-worn recording device, the computing device, and the user interface device are all worn on the law enforcement officer. In example embodiments, the recording device, computing device, and user interface device are all contained in a single device or within a single housing. In other example embodiments, the system includes a plurality of separate devices configured to interface with one another. In the example embodiment of FIG. 2, the computing device is external to the law enforcement officer and communicates wirelessly with the body-worn recording device and the user interface device. In other embodiments, the threat detection and warning system integrates with other Law Enforcement devices including communication and recording devices, as shown in FIG. 3. The threat detection and warning system worn by a law enforcement officer can also be configured to integrate with the threat detection and warning systems worn by other law enforcement officers in the general vicinity.

The body-worn recording device is generally capable of capturing video and/or audio data. In example embodiments, the recording device includes a high definition camera configured to capture video images. For example, the “high definition” camera can have a resolution of 1980×1080, although those skilled in the art will recognize that various resolution formats can provide sufficiently clear and detailed images, suitable for evidence gathering and evaluative processing. For example, even 720 p (720×1024) would work. The body-worn recording device can include multiple sensors including video, audio, and vibratory sensors. In this regard, the “recording device” can simply be a sensor that doesn't itself store any data (like a digital camera sensor). Thus, the body-worn recording device can comprise one or more sensors or one or more actual recording devices (with storage).

The recording device can be controlled manually by the user or can be automatically triggered by either an external or internally-derived signal. An external triggering signal can be from another similar device already recording, a signal from a vehicle-based device that has been triggered, or from another device within range. An internal trigger can be derived by analyzing data collected locally by the computing device. The recording device can also be triggered automatically by a set of situational parameters, for example if a law enforcement officer leaves his patrol car. In embodiments where a law enforcement officer's threat detection and warning system is able to communicate with the threat detection systems of other officers, the recording device can be activated when the system is in close proximity to another activated threat detection system or vehicle-based recording device.

The computing device is configured to analyze the data from the recording device sensor or sensors to identify threats or information of interest. The computing device preferably has sufficient computing capacity to analyze data and identify threats in a short time such that the information will be useful to the law enforcement officer (more or less in real time). The algorithms and computing capacity should also be configured to reduce false positives to a negligible level. In example embodiments, the computing device is worn on the body of the law enforcement officer, like the recording device, as shown in FIG. 1. In other embodiments, the computing device can include a processor, for example in a police vehicle, which communicates wirelessly with the recording device and user interface device, as shown in FIG. 2. In other embodiments, the computing device can include a cloud-based device that communicates with the recording device and user interface device via a Wi-Fi-hotspot or cellular connection.

Thus, the principal components of the system can be integrated into a single housing/device to be worn by the officer. Alternatively, the principal components can be separate elements, all of which may be worn or only some of which may be worn. Likewise, the communication between the principal components can be by a direct electrical communication, such as by copper wires, or can be wireless.

Threats can include identification of weapons, persons of interest, or suspicious behavior. Example analysis can include facial recognition algorithms that compare faces captured from visual sensors against databases of wanted or missing persons. The computing device can also analyze images to identify weapons or other dangerous objects. For example, the computing device can analyze video and images to determine if an object that a person is holding is a dangerous weapon or a mere cell phone. The near-ubiquitous use of cell phones means that many, many people that a law enforcement officer encounters will be carrying something in that person's hand. Thus, it can be critical to the safety of the officer and the person encountered by the officer to discriminate weapons from non-weapons quickly and accurately.

The computing device can also analyze video and images to determine if a citizen has any concealed weapons (not just weapons that are in plain sight). The computing device can also determine whether an object is a threat based on contextual analysis. For example, when a bottle is being held straight (right-side up), it is generally not a threat, but if it is held upside-down it can be used as a weapon. The computing device can also analyze video captures to detect sudden movement. For example, if the body-worn recording device includes a video recording device positioned to record behind the law enforcement officer, the computing device can detect if a suspect is approaching the officer from behind.

In example embodiments, the computing device can include real time sentiment analysis during interactions with citizens or potential suspects. The sentiment analysis looks at body language, facial expressions, eye movement, and intonation to determine the citizen/suspect's truthfulness and intentions. Sentiment analysis can also include real time feeling analysis. The computing device can determine a citizen/suspects reaction and feelings (happiness, sadness, anger, irritation, etc.) in response to certain questions, comments, and observations. For example, an officer will often ask questions, make comments or do something to see how a person responds to the stimuli. A certain response, such as a grimace or raised eyebrow, may mean something in that context, providing a clue as to the mindset of the person encountered (such as truthfulness, intentions, nervousness, anger, etc.). As of the filing of this application, some companies have developed and marketed technologies for performing such evaluations. For example, a machine vision artificial intelligence technology known as Sighthound Sentry from Sighthound of Winter Park, Fla., purportedly brings such evaluations to computer vision equipment. See, https://www.sighthound.com/products/sighthound-sentry. Also, facial recognition software allows for relatively rapid searches of ID databases to identify persons encountered. The present system integrates such technologies and does so in the context of AI (artificial intelligence). As such, the computer continually learns as it goes to make more informed and better evaluations/determinations over time.

The computing device can also analyze audio captures to identify threats. For example, the sound of a gunshot or a person screaming might not be detected by the law enforcement officer just by listening, especially if the officer is patrolling in a high volume area, such as a crowded concert venue. The computing device can amplify recorded audio to detect and identify threats and identify their position relative to the officer. In example embodiments, the computing device can automatically archive data upon identification of a threat.

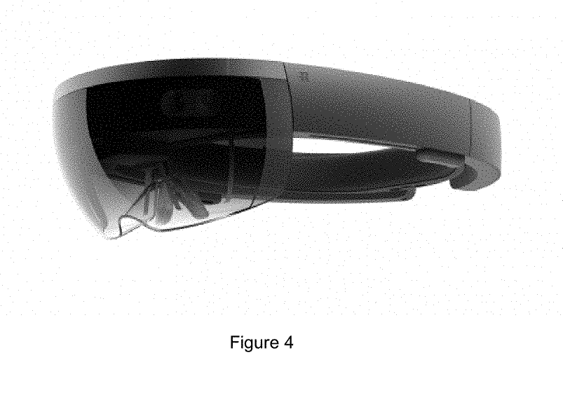

The user interface device is configured to notify the law enforcement officer when the computing device has detected a threat or situation of interest. Upon identification of the threat, the device will notify the officer through audible, visual, or vibratory feedback as appropriate for the situation. Example user interface devices include a mobile electronic device such as a cell phone or a smart watch. In example embodiments, the user interface device is an Augmented Reality User Interface (AR UI) device such as a visor, glasses, or contact lenses capable of displaying data in an augmented reality method. An example AR UI device is HoloLens by Microsoft as shown in FIG. 4. The user interface device can also be configured to receive user input. For example, the law enforcement officer can use the user interface device to engage or disengage the threat detection system, request more information about a particular threat, or access archived data.

Generally, the feedback should include the type of threat and its relative location. The feedback can also include a confidence level of the threat. The information can be displayed in a text-based and/or graphic format when the user interface device allows. The display would be relevant to the specific threat. For example, when the computing device identifies a person of interest, the person's identity will be displayed on the user interface device. This display can include a photograph and biographical information. When the computing device identifies a weapon the display can include a photograph of the suspect with the weapon highlighted. When the computing device is providing sentiment analysis the user interface device can provide suggestions to the law enforcement officer as to when a citizen/suspect is being truthful and allow the officer to navigate/change the engagement with the citizen to ensure optimal outcomes.

In example embodiments, the threat detection and warning system can integrate with other law enforcement devices to increase the amount of data and threat detection capabilities of the system. For example, the computing device can collect data not only from the body-worn recording device worn by the law enforcement officer but also from other sources. For example, the computing device can collect visual data from the officer's patrol car camera, stationary security cameras, or the body-worn cameras of other officers in the area. In a situation where the law enforcement officer's view of the threat is unclear or obscured, data from multiple cameras positioned at multiple angles can be combined to provide a better picture of the threat. This information can be shared with all officers in the area.

Integration of multiple threat detection systems on officers within a prescribed vicinity can provide advantages such as blind side protection. For example, in a situation with multiple officers responding, officer A's threat detection system may identify a threat, but the threat is moving toward officer B, whose back is turned towards the threat. officer A's threat detection system can alert officer B's threat detection system of the blind side threat in time for officer B to respond accordingly. In other examples, the integration of multiple threat detection systems can provide greater response time when a law enforcement officer is in need of assistance. For example, if officer A's threat detection system identifies a threat, it can alert officer B who can be hundreds of feet away. Officer B can decide to go aid officer A before officer A may have time to call for backup.

The threat detection systems can also include geo-positioning technology to help other officers in the area track a moving threat such as a fleeing suspect. In example embodiments, an officer can use their user interface device to access audio, visual, and other data from surrounding threat detection systems in order to gain a better understanding of the situation. For example, if the law enforcement officer hears a shooting in the distance, the officer, through his user interface device, would be able to see that there is another officer in that direction. He can then actively pull up the audio, video, and other sensor feeds from that location. The threat detection system can also provide situational awareness from historical data. For example, if a person of interest or missing person was last spotted at a particular location, when a law enforcement officer is passing through that location, the threat detection system can send an alert to the user interface device.

A threat detection application according to an example embodiment of the invention (software) can be implemented in various platforms in various ways. For example, the application can be implemented in portable handheld communication devices, like cellular telephones. Also, it can be implemented in tablets, laptops, and other field-deployed electronic equipment. Also, it can be implemented in computer workstations, servers, or the like on premises. Further, it can be implemented in a cloud-based computing environment for remote access by the users.

Optionally, the system can be implemented in conjunction with existing field equipment, such as existing body-cams. The output of such body-cams can be hard wired or sent wirelessly to the computing device for analysis and assessment of threats, which threats are then indicated to the officer in any of a number of ways, including through the use of a smart watch, ear bud, or visor type of device. In one particular form, the alert device can take the form of an augmented reality headset. Also optionally, while separate devices (sensor/body-cam, computing device, feedback device) are one way of implementing the system, those skilled in the art will recognize that a single device can be provided that has the various components incorporated into one physical enclosure to be worn by the officer.

From the standpoint of the method, the invention comprises the steps of: (a) capturing data from a body-worn sensor (such as audio or video); (b) analyzing the captured data to assess possible threats; (c) optionally recording the captured data or otherwise preserving the data; and (d) communicating the assessed threat to the law enforcement officer wearing the sensor.

Generally, in terms of hardware architecture, the system includes a processor, a computer readable medium such as memory, and one or more input and/or output (I/O) devices (or peripherals) that are communicatively coupled via a local interface. For example, the local interface can be, but is not limited to, one or more buses or other wired or wireless connections as is known in the art. The local interface may have additional elements, which have been omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software that can be stored in memory. The processor can be virtually any custom made or commercially available processor, a central processing unit (CPU), data signal processor (DSP) or an auxiliary processor among several processors associated with the server, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory can include any one or a combination of volatile memory elements. For example, random access memory (RAM), dynamic random access memory (DRAM), static random access memory (SRAM), or nonvolatile memory elements (e.g., ROM, programmable read only memory (PROM), erasable programmable read only memory (EPROM), electronically erasable programmable read only memory (EEPROM), tape, compact disc read only memory (CD-ROM), disk, diskette, cartridge, cassette or the like). Moreover, the memory may incorporate electronic, magnetic, optical, and/or other types of storage media. Note that the memory can have a distributed architecture, where various components are situated remote from one another, but can be accessed by the processor.

The software in memory may include one or more separate programs, each of which comprises an ordered listing of executable instructions for implementing logical functions. In the example, the software in the memory includes a suitable operating system (O/S) and the threat detection system of the present invention. As illustrated, the system of the present invention comprises numerous functional components.

A non-exhaustive list of examples of suitable commercially available operating systems includes the following: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from Wind River Systems, Inc.; or (f) an appliance-based operating system, such as that implemented in handheld computers or personal data assistants (PDAs) (e.g., Symbian OS available from Symbian, Inc., Palm OS available from Palm Computing, Inc., and Windows CE available from Microsoft Corporation).

The operating system essentially controls the execution of other computer programs, such as the threat detection system, and provides scheduling, input-output control, file and data management, memory management, and communication control and related services. However, it is contemplated by the inventors that the selectable threat detection system of the present invention is applicable on all other commercially available operating systems.

The threat detection system may include a source program, executable program (object code), script, or any other entity comprising a set of computer program instructions to be performed. If threat detection system includes a source program, then the program may be translated via a compiler, assembler, interpreter, or the like, which may or may not be included within the memory, to operate properly in connection with the O/S. Furthermore, the threat detection system can be written as: (a) an object oriented programming language, which has classes of data and methods; or (b) a procedure programming language, which has routines, subroutines, and/or functions, for example, but not limited to, C, C++, C#, Smalltalk, Pascal, BASIC, API calls, HTML, XHTML, XML, ASP scripts, FORTRAN, COBOL, Perl, Java, Javascript, Python, ADA, .NET, and the like. The computer program instructions may execute entirely on server, partly on the server, as a stand-alone software package, partly on server and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner such that the instructions stored in the computer readable medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus.

The I/O devices may include input devices, for example, but not limited to, a mouse, keyboard, scanner (not shown), microphone (not shown), etc. Furthermore, the I/O devices may also include output devices, for example but not limited to, a printer (not shown), display, etc. Finally, the I/O devices may include devices that communicate both inputs and outputs, for example, but not limited to, a NIC or modulator/demodulator (for accessing remote devices, other files, devices, systems, or a network), a radio frequency (RF) or other transceiver (not shown), a telephonic interface (not shown), a bridge (not shown), a router (not shown), etc.

If the server is a PC, workstation, intelligent device or the like, the software in the memory may further include a basic input output system (BIOS) (omitted for simplicity). The BIOS is a set of essential software routines that initialize and test hardware at startup, start the O/S, and support the transfer of data among the hardware devices. The BIOS is stored in some type of read-only-memory, such as ROM, PROM, EPROM, EEPROM or the like, so that the BIOS can be executed when the server is activated.

When the server is in operation, the processor is configured to execute software stored within the memory, to communicate data to and from the memory, and, generally, to control operations of the server are pursuant to the software. The threat detection system and the O/S are read, in whole or in part, by the processor, perhaps buffered within the processor, and then executed.

When the threat detection system is implemented at least partially in software, it should be noted that the threat detection system can be embodied in any computer-readable medium for use by, or in connection with, an instruction execution system, apparatus, or device such as a computer-based system, processor-containing system, or other system that can fetch the instructions from the instruction execution system, apparatus, or device and execute the instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the context of this document, a “computer-readable medium” can be any means that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a non-exhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

Program code embodied on a computer readable medium may be transmitted using any appropriate medium, including, but not limited to, wireless, wireline, optical fiber cable, RF, etc., or any suitable combination of the foregoing.

In an alternative embodiment, the threat detection system can be implemented with any one or a combination of the following technologies, which are each well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In an example embodiment, the present invention relates to a personal threat detection and warning system for use by a law enforcement officer and includes a body-worn sensing device capable of sensing at least one of audio data or visual data. A computing device is coupled to the body-worn sensing device and configured to analyze data from the body-worn sensing device. The computing device is configured to identify threats based on the data received from the body-worn recording device. A user interface device is coupled to the computing device for receiving signals therefrom and for providing threat warnings to the law enforcement officer regarding the identified threat(s). Optionally, the computing device is worn on the body of the law enforcement officer. Also optionally, the body-worn recording device includes a high definition camera. Optionally, the user interface device includes multiple visible, audible, and vibratory indicators.

Preferably, the personal threat detection and warning system can be activated and deactivated by the law enforcement officer manually. Additionally or alternatively, the personal threat detection and warning system can be activated and deactivated automatically. Preferably, the personal threat detection and warning system is automatically enabled when it detects another activated personal threat detection and warning system in the vicinity.

Preferably, the computing device identifies threats with a type of threat and a physical location relative to the law enforcement officer, wherein the user interface device provides a positive indicator of the threat including the type of threat and the threat location.

Preferably, the user interface device can include an augmented reality user interface (AR UI). Preferably, this takes the form of a headset or visor. Optionally, the user interface device can include a wrist-worn device for providing surreptitious vibratory alerts to the law enforcement officer, such as a so-called smart watch.

While the claimed invention has been shown and described in example forms, it will be apparent to those skilled in the art that many modifications, additions, and deletions can be made therein without departing from the spirit and scope of the invention as defined by the following claims.

1. A personal threat detection and warning system for use by a law enforcement officer, the system comprising:
a body-worn sensing device capable of sensing at least one of audio data or visual data, wherein the body-worn sensing device includes a camera;
a computing device coupled to the body-worn sensing device and configured to analyze data from the body-worn sensing device, wherein the computing device is configured to identify threats based on the data received from the body-worn sensing device, wherein the computing device is worn on the body of the law enforcement officer;
a user interface device coupled to the computing device for receiving signals therefrom and for providing threat warnings to the law enforcement officer regarding the identified threat(s); and
wherein the computing device identifies threats with a type of threat and a physical location relative to the law enforcement officer, wherein the user interface device provides a positive indicator of the threat including the type of threat and the threat location.

2. (canceled)

3. (canceled)

4. A personal threat detection and warning system for a law enforcement officer as claimed in claim 1, wherein the user interface device includes multiple visible, audible, and vibratory indicators.

5. A personal threat detection and warning system for a law enforcement officer as claimed in claim 1, wherein the personal threat detection and warning system can be activated and deactivated by the law enforcement officer manually.

6. A personal threat detection and warning system for a law enforcement officer as claimed in claim 1, wherein the personal threat detection and warning system can be activated and deactivated automatically.

7. A personal threat detection and warning system for a law enforcement officer as claimed in claim 1, wherein the personal threat detection and warning system is adapted to communicate with other law enforcement devices.

8. A personal threat detection and warning system for a law enforcement officer as claimed in claim 7, wherein the other law enforcement devices includes other personal threat detection and warning systems.

9. A personal threat detection and warning system for a law enforcement officer as claimed in claim 7, wherein the personal threat detection and warning system is automatically enabled when it detects another activated personal threat detection and warning system in the vicinity.

10. A personal threat detection and warning system for a law enforcement officer as claimed in claim 1, wherein the threats identified includes one of an object of interest, a situation of interest or a person of interest.

11. (canceled)

12. A personal threat detection and warning system for a law enforcement officer as claimed in claim 1, wherein the user interface device comprises an augmented reality user interface (AR UI).

13. A personal threat detection and warning system for a law enforcement officer as claimed in claim 1, wherein the user interface device comprises a wrist-worn device for providing surreptitious vibratory alerts to the law enforcement officer.

14. A personal threat detection and warning system for a law enforcement officer as claimed in claim 13, wherein the user interface device comprises a smart watch.

15. A personal threat detection and warning system for a law enforcement officer as claimed in claim 1, wherein the body-worn sensing device comprises a recording device.

16. A personal threat detection and warning system for a law enforcement officer as claimed in claim 15, wherein the body-worn sensing device comprises a body-cam device.

17. (canceled)

18. (canceled)

19. (canceled)

20. (canceled)

21. (canceled)
